(19) United States
(12) Patent Application Publication
(10) Pub. No.: US 2010/0297974 A1
(43) Pub. Date: Nov. 25, 2010

(54) ORTHOGONALITY COMPENSATING DEVICE, RADIO RECEIVING DEVICE, ORTHOGONALITY COMPENSATING METHOD, AND NON-TRANSITORY COMPUTER READABLE MEDIUM

(75) Inventors: Yuji YAMAMOTO, Kanagawa (JP); Ryouichi Yokoyama, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/766,634

(22) Filed: Apr. 23, 2010

(30) Foreign Application Priority Data
May 19, 2009 (JP) 2009-120745

(51) Int. Cl. H04B 1/10

(52) U.S. Cl. 455/285

(57) ABSTRACT

Provided is an orthogonality compensating device that compensates for orthogonality between a real signal and an imaginary signal of complex digital intermediate frequency signals, the orthogonality compensating device including: a detector that outputs a detection result indicating whether the complex digital intermediate frequency signals include an image frequency signal; a first processing unit that outputs a first signal obtained by adding a first scalar signal obtained by multiplying the imaginary signal by h1 and a second scalar signal obtained by multiplying the real signal by h2; a second processing unit that outputs a second signal obtained by multiplying the imaginary signal by h3; and a coefficient specifying unit that specifies h1 and h3 such that the first signal has the same amplitude as the second signal, specifies h2 such that the first signal is orthogonal to the second signal, and selects a sign of h2 depending on the detection result.

### INCORPORATION BY REFERENCE

This application is based upon and claims the benefit of priority from Japanese patent application No. 2009-120745, filed on May 19, 2009, the disclosure of which is incorporated herein in its entirety by reference.

### BACKGROUND

1. Field of the Invention

The present invention relates to a radio receiving device having a function of frequency conversion such as superheterodyne, and particularly to a radio receiving device having a function to eliminate an image frequency signal that has a complex conjugate relationship with a radio received signal.

2. Description of Related Art

Heretofore, techniques to eliminate an image frequency signal have been proposed. For example, Japanese Patent No. 3902498 discloses a radio signal receiving device having a function of orthogonal frequency conversion. FIG. 5 shows a configuration of a radio signal receiving device disclosed in Japanese Patent No. 3902498. An orthogonal detector 2 converts received radio signals including a desired frequency signal received by an antenna device 1 into complex intermediate frequency signals by frequency-converting the received signals using a signal cos and a signal −sin, which are output from a local-generated signal generator 21, by mixers 22 and 23, respectively. The complex intermediate frequency signals are quantized by each of analog-digital converters (ADCs) 3a and 3b, and orthogonality and amplitude characteristics of the signals are compensated for by a characteristic compensator 4, and the compensated signals are inputted to a complex mixer 5. The complex mixer 5 completely cancels the image frequency signal, which has a complex conjugate relationship with the desired frequency signal, from the signals whose orthogonality and amplitude characteristics are compensated for in principle to generate only the desired frequency signal. Only the desired frequency signal is sent to a wave detector 6 and is subjected to detection processing. Then, the desired frequency signal is transferred to a latter processing phase to provide users with services.

For the sake of easy explanation, modulating information is omitted, and only a signal carrier is taken into consideration. It is assumed that a desired frequency signal is represented by cos (x+fif), an image frequency signal which has a complex conjugate relationship with the desired frequency signal is represented by cos (x−fif), and a signal output from the local-generated signal generator 21 is represented by cos (x) or −sin (x). Symbols x and fif represent values that satisfy 0≦x<360°, 0≦fif<360°, 0≦x+fif<360°, and 0≦x−fif<360°.

In the case of receiving the desired frequency signal, an output signal (signal F22) from the mixer 22 is represented as follows.

$$\begin{matrix}F 22 = cos ( x + fif ) * cos ( x ) \\ = 0.5 * cos ( fif )\end{matrix}$$

An output signal (signal F23) from the mixer 23 is expressed as follows.

$$\begin{matrix}F 23 = cos ( x + fif ) * \{ - sin ( x ) \} \\ = 0.5 * sin ( fif )\end{matrix}$$

A high frequency component occurring in the mixers 22 and 23 is eliminated by a filtering processing (not shown), so that the complex intermediate frequency signals are composed of only low frequency signals. Detailed description is omitted here.

In the complex mixer 5, the signals F22 and F23 are converted using the signal cos(fif) or the signal −sin(fif) and are obtained as follows.

$$F 22 * cos ( fif ) - F 23 * \{ - sin ( fif ) \} = 0.5 * cos ( fif ) cos ( fif ) + 0.5 * sin ( fif ) sin ( fif ) = 0.25 * cos ( 2 * fif ) + 0.25 * cos ( 0 ) - 0.25 * cos ( 2 * fif ) + 0.25 * cos ( 0 ) = 0.5 * cos ( 0 ) \qquad ( 1 )$$

Further,

$$F 23 * cos ( fif ) + F 22 * \{ - sin ( fif ) \} = 0.5 * sin ( fif ) cos ( fif ) - 0.5 * cos ( fif ) sin ( fif ) = 0.25 * sin ( 2 * fif ) + 0.25 * sin ( 0 ) - 0.25 * sin ( 2 * fif ) + 0.25 * sin ( 0 ) = 0.5 * sin ( 0 ) \qquad ( 2 )$$

In the case of receiving the image frequency signal, the output signal from the mixer 22 is represented as follows.

$$\begin{matrix}F 22 = cos ( x - fif ) * cos ( x ) \\ = 0.5 * cos ( fif )\end{matrix}$$

The output signal from the mixer 23 is expressed as follows.

$$\begin{matrix}F 23 = cos ( x - fif ) * \{ - sin ( x ) \} \\ = - 0.5 * sin ( fif )\end{matrix}$$

As noted in the description of the reception of the desired frequency signal, a high frequency component occurring in the mixers 22 and 23 is eliminated by a filtering processing (not shown), so that the complex intermediate frequency signals are composed of only low frequency signals.

In the complex mixer 5, the signals F22 and F23 are converted using the signal cos(fif) and the signal −sin(fif) and are obtained as follows.

$$F 22 * cos ( fif ) - F 23 * \{ - sin ( fif ) \} = 0.5 * cos ( fif ) cos ( fif ) - 0.5 * sin ( fif ) sin ( fif ) = 0.25 * cos ( 2 * fif ) + 0.25 * cos ( 0 ) + 0.25 * cos ( 2 * fif ) - 0.25 * cos ( 0 ) = 0.5 * cos ( 2 * fif ) \qquad ( 3 )$$

### Further,

$$F 23 * cos ( fif ) + F 22 * \{ - sin ( fif ) \} = - 0.5 * sin ( fif ) cos ( fif ) - 0.5 * cos ( fif ) sin ( fif ) = - 0.25 * sin ( 2 * fif ) - 0.25 * sin ( 0 ) - 0.25 * sin ( 2 * fif ) + 0.25 * sin ( 0 ) = - 0.5 * sin ( 2 * fif ) \qquad ( 4 )$$

That is, the expressions (1) and (2) show that the desired frequency signal is converted into a zero IF signal by the complex mixer 5, and the expressions (3) and (4) show that the image frequency signal is subjected to complex transformation in a high frequency range. Consequently, it can be explained that the complex mixer 5 divides the desired frequency signal and the image frequency signal, and a low-pass filter removes a high frequency component, thereby completely canceling the image frequency signal from the desired frequency signal.

The radio signal receiving device as described above is able to downsize high frequency components, such as an analog filter for removing an image frequency signal, or an antenna tuner. This contributes to a reduction in cost, and thus the radio signal receiving device is applied to a wide range of fields such as a television tuner, a satellite broadcasting receiver, a communication instrument, or the like.

As noted above, an image frequency signal can be completely canceled in theory. However, practically, there are variations in circuit characteristics and property fluctuation depending on temperature change. Therefore, it is effective to compensate for the characteristics by a specific adaptive signal processing in the characteristic compensator 4. Japanese Patent No. 3439036 discloses an example of the characteristic compensator 4 disclosed in Japanese Patent No. 3902498. Japanese Patent No. 3439036 discloses a specific example of an orthogonality and amplitude error compensating circuit to perform the adaptive signal processing. FIG. 6 shows a configuration of an amplitude error compensating circuit disclosed in Japanese Patent No. 3439036. An embodiment of Japanese Patent No. 3439036 specifies that coefficients h1, h2, and h3 of FIG. 6 are processed by the adaptive signal processing. This makes it possible to compensate for the characteristics with high accuracy.

The orthogonality and amplitude error compensating circuit disclosed in Japanese Patent No. 3439036 uses CMA (Constant Modules Algorithm) as an evaluation function for performing the adaptive signal processing. Coefficient update expressions used in Japanese Patent No. 3439036 are as follows.

h_{1,k}=h_{1,k-1}+μ(Y.Q)*(S.Q)e

h_{2,k}=h_{2,k-1}+μ(Y.I)*(S.Q)e

h_{3,k}=h_{3,k-1}+μ(Y.I)*(S.I)e

where σ denotes an amplitude value of a desired signal, and

e=σ²−(Y.I²+Y.Q²) (5)

Further, k is an integer greater than zero (k>0) and indicates an elapsed time.

Processing of the expressions Y.I=h3*S.I and Y.Q=h1*S.Q+h2*S.I is preformed using the coefficients h1, h2, and h3, which are adaptively updated by the expression (5), to thereby obtain a real number axis signal (Y1) and an imaginary number axis signal (Y.Q) whose orthogonality and amplitude error are compensated for.

The updating expression of the coefficient h_{2,k} as shown in the expression (5) is used to compensate for orthogornality between Y.I and Y.Q. When the orthogonality is maintained, the value “e” is zero. That is, the coefficient h2 is held at a value obtained when the orthogonality is maintained.

The adaptability of the device disclosed in Japanese Patent No. 3902498 using the technique of Japanese Patent No. 3439036 described above significantly reduced depending on a difference in signal level between the desired frequency signal and the image frequency signal, quality characteristics of the input signal, or the like. In order to prevent this shortage, the level of the image frequency signal is detected, the adaptive signal processing is performed when the level of the image frequency signal is equal to or greater than a threshold, and the adaptive signal processing is suspended when the level of the image frequency signal is less than the threshold. Therefore, until detection of a condition where the image frequency signal is relatively stable, users cannot receive satisfactory service, because users have to receive the desired frequency signal which is interfered by an image disturbing signal.

The coefficients represented by the expression (5), which are converged by adaptive signal processing while the image frequency signal is stable, maintain the orthogonality with respect to the image frequency signal, but the coefficients do not maintain the orthogonality with respect to the desired frequency signal. This makes a difference to the detection performance of a detection output from the wave detector 6.

Further, in the technique disclosed in Japanese Patent No. 3902498, when the adaptive signal processing is performed in a condition where the desired frequency signal and the image frequency signal coexist, there are variation factors such as a variation factor due to reverse directions of adaptive control, and a variation factor due to a forward direction of adaptive control. In the case of the variation factor due to the reverse directions of adaptive control, the orthogonality is not compensated. In the technique disclosed in Japanese Patent No. 3902498, the adaptive signal processing is performed exclusively when the image frequency signal is relatively stable, thereby preventing this problem.

In general, the orthogornality is lost due to variations of device circuit characteristics and property fluctuation caused by temperature change, such as an orthogonality variation between the signal cos and signal −sin output from the local-generated signal generator 21, or a delay variation in the mixers 22 and 23 as shown in FIG. 5. Though not shown in FIG. 5, in practice, an analog filter needs to be provided between the orthogonal detector 2 and the ADCs 3a and 3b, which causes a group delay variation.

Japanese Patent No. 3439036 discloses that it is effective to perform characteristics compensation by the adaptive signal processing in the characteristic compensator 4 in order to compensate for these variations. Here, the above-mentioned analog filter is a factor that causes the reverse directions of the adaptive control between the desired frequency signal and the image frequency signal. The analog filter has an influence on the group delay variation. This reason will be explained, assuming that a phase error β occurs in the ADC 3b alone.

In the case of receiving the desired frequency signal, when the amplitude of each input to the characteristic compensator 4 is normalized to one, the following expressions are obtained.

S.I=cos(fif)

S.Q=sin(fif+β)

The characteristic compensator 4 adaptively changes the coefficient h2 so as to compensate for the orthogonality.

$$\begin{matrix}Y . I = cos ( fif ) \\ Y . Q = sin ( fif + β ) + h 2 * cos ( fif ) \\ = √ \{ 1 + {( h 2 )}^{2} \} * sin ( fif + β + θ )\end{matrix} \\ where θ = {sin}^{- 1} ( h 2 / √ \{ 1 + {( h 2 )}^{2} \} ) \qquad ( 6 )$$

That is, when the adaptive control is performed to adjust the second coefficient h2 so as to satisfy θ=−β, the expression (6) is transformed as follows.

√{1+(h2)²}*sin(fif)

The amplitude error is controlled by the coefficients h1 and h3. A detailed description thereof is omitted so as not to detract from the present invention.

In the case of receiving the image frequency signal, when the amplitude of each input to the characteristic compensator 4 is normalized to one, the following expressions are obtained.

S.I=cos(fif)

S.Q=−sin(fif+β)

The compensator 4 adaptively changes the second coefficient h2 so as to compensate for the orthogonality.

$$\begin{matrix}Y . I = cos ( fif ) \\ Y . Q = sin ( - fif - β ) + h 2 * cos ( fif ) \\ = √ \{ 1 + {( h 2 )}^{2} \} * sin ( - fif - β + θ )\end{matrix} \\ where θ = {sin}^{- 1} ( h 2 / √ \{ 1 + {( h 2 )}^{2} \} ) \qquad ( 7 )$$

That is, when the adaptive control is performed to adjust the second coefficient h2 so as to satisfy θ=0, the expression (7) is transformed as follows.

−√{1+(h2)²}*sin(fif)″

The amplitude error is controlled by the coefficients h1 and h3. A detailed description thereof is omitted so as not to detract from the present invention.

As described above, in each case of receiving the desired frequency signal and the image frequency signal, when the phase error β occurs, the directions of the adaptive control are reverse to each other. For this reason, it is necessary that the image frequency signal and the desired frequency signal exist separately in order to control orthogonality compensation.

For example, it is assumed that γ denotes a phase correction amount calculated using a coefficient shown in the expression (5) which is corrected using the image frequency signal. When the desired frequency signal is received in this condition, a phase difference of −2γ occurs in the desired frequency signal. Thus the orthogonality with respect to the desired frequency signal is not compensated.

Factors that cause the directions of adaptive control for the desired frequency signal and image frequency signal to coincide with each other include an orthogonality variation between the signal con and signal −sin output from the local-generated signal generator 21 shown in FIG. 5. This is explained below.

It is assumed that the phase error a occurs in the signal −sin alone. In the case of receiving the desired frequency signal, an output form the mixer 22 is expressed as follows.

$$\begin{matrix}F 22 = cos ( x + fif ) * cos ( x ) \\ = 0.5 * cos ( fif )\end{matrix}$$

An output from the mixer 23 is expressed as follows.

$$\begin{matrix}F 23 = cos ( x + fif ) * \{ - sin ( x + α ) \} \\ = 0.5 * sin ( fif - α )\end{matrix}$$

When the amplitude of each input to the characteristic compensator 4 is normalized to one, the following expressions are obtained.

S.I=cos(fif)

S.Q=sin(fif−α)

The characteristic compensator 4 adaptively changes the second coefficient h2 so as to compensate for the orthogonality.

$$\begin{matrix}Y . I = cos ( fif ) \\ Y . Q = sin ( fif - α ) + h 2 * cos ( fif ) \\ = √ \{ 1 + {( h 2 )}^{2} \} * sin ( fif - α + θ )\end{matrix} \\ where θ = {sin}^{- 1} ( h 2 / √ \{ 1 + {( h 2 )}^{2} \} ) \qquad ( 8 )$$

That is, when the adaptive control is performed to adjust the second coefficient h2 so as to satisfy θ=α, the expression (8) is transformed as follows.

√{1+(h2)²}*sin(fif)

The amplitude error is controlled by the coefficients h1 and h3. A detailed description thereof is omitted so as not to detract from the present invention.

In the case of receiving the image frequency signal, an output from the mixer 22 is expressed as follows.

$$\begin{matrix}F 22 = cos ( x - fif ) * cos ( x ) \\ = 0.5 * cos ( fif )\end{matrix}$$

An output from the mixer 23 is expressed as follows.

$$\begin{matrix}F 23 = cos ( x - fif ) * \{ - sin ( x + α ) \} \\ = 0.5 * sin ( - fif - α )\end{matrix}$$

When the amplitude of each input to the characteristic compensator 4 is normalized to one, the following expressions are obtained.

S.I=cos(fif)

S.Q=sin(−fif−α)

The characteristic compensator 4 adaptively changes the second coefficient h2 so as to compensate for the orthogonality.

$$\begin{matrix}Y . I = cos ( fif ) \\ Y . Q = sin ( - fif - α ) + h 2 * cos ( fif ) \\ = √ \{ 1 + {( h 2 )}^{2} \} * sin ( - fif - α + θ )\end{matrix} \\ where θ = {sin}^{- 1} ( h 2 / √ \{ 1 + {( h 2 )}^{2} \} ) \qquad ( 9 )$$

That is, when the adaptive control is performed to adjust the second coefficient h2 so as to satisfy θ=α, the expression (9) is transformed as follows.

√{1+(h2)²}*sin(fif)

The amplitude error is controlled by the coefficients h1 and h3. A detailed description thereof is omitted so as not to detract from the present invention.

As described above, in each case of receiving the desired frequency signal and the image frequency signal, when the phase error a occurs, the directions of the adaptive control coincide with each other.

In general, the signal cos and the signal −sin occur in the device. Even though an absolute delay occurs, variations due to relative factors can be suppressed. However, the analog filter is a discrete component, and therefore has a large relative variation. That is, the phase error β is more liable to occur than the phase error α.

If the factors for the phase error β are large, the ability of adaptive control deteriorates when the image frequency signal and the desired frequency signal coexist. Therefore, the related art proposes that, upon detection of the level of the image frequency signal, the adaptive control is performed when the image frequency is equal to or greater than a given threshold, and the adaptive control is suspended when the image frequency signal is smaller than the threshold, thereby avoiding deterioration in the ability of adaptive control. As a result, until detection of a condition where the image frequency signal is relatively stable, users have to receive the desired frequency signal interfered by the image frequency signal, and cannot receive satisfactory service.

### SUMMARY

The present inventors have found a problem that there is no technique to compensate for the orthogonality even when both of the desired frequency signal and the image frequency signal coexist.

A first exemplary aspect of the present invention is orthogonality compensating device that compensates for orthogonality between a real signal and an imaginary signal of complex digital intermediate frequency signals, the orthogonality compensating device including: a detector, a first processing unit, a second processing unit, and a coefficient specifying unit. The detector outputs a detection result including whether the complex digital intermediate frequency signals include an image frequency signal having a complex conjugate relationship with a frequency of a desired frequency signal. The first processing unit that outputs a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient. The second processing unit outputs a second signal obtained by multiplying the other of the real signal and the imaginary signal by a third coefficient. The coefficient specifying unit specifies the first coefficient and the third coefficient such that the first signal has the same amplitude as the second signal, specifies the second coefficient such that the first signal is orthogonal to the second signal, and selects a sign of the second coefficient depending on the detection result from the detector.

The value of a coefficient (second coefficient h2 used) to compensate for the orthogonality between the real signal and the imaginary signal, that is, the coefficient subjected to orthogonality compensation with the desired frequency signal by the first processing unit is effective to receive the image frequency signal, even when the sign of the coefficient value obtained by the image frequency signal and the sign of the coefficient value obtained by the desired frequency signal are reverse to each other. This provides an advantageous effect that an ability to eliminate the image frequency signal is obtained without waiting for an arrival of the image frequency signal.

A second exemplary aspect of the present invention is a radio receiving device including: a frequency converter that obtains complex intermediate frequency signals depending on a frequency of a received signal by using a local signal represented by a complex signal; a quantizer that transforms the complex intermediate frequency signals to complex digital intermediate frequency signals; an orthogonal compensator that compensates for orthogonality between a real signal and a imaginary signal of the complex digital intermediate frequency signals by using the orthogonality compensating device described above; a complex mixer that divides the complex digital intermediate frequency signals compensated for by the orthogonal compensator into the desired frequency signal and the image frequency signal in accordance with a frequency range, the image frequency signal falling within a rage of image frequency having a complex conjugate relationship with a frequency of the desired frequency signal; and a detector that detects a signal output from the complex mixer.

Further, a third exemplary aspect of the present invention is a orthogonality compensating method that compensates for orthogonality between a real signal and an imaginary signal of complex digital intermediate frequency signals, the orthogonality compensating method including: outputting a detection result indicating whether the complex digital intermediate frequency signals include an image frequency signal having a complex conjugate relationship with a frequency of desired frequency signal; outputting a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient; outputting a second signal obtained by multiplying the other of the real signal and the imaginary signal by a third coefficient; specifying the first coefficient and the third coefficient in such a way that the first signal has the same amplitude as the second signal;

specifying the second coefficient in such a way that the first signal is orthogonal to the second signal; and selecting a sign of the second coefficient depending on the detection result.

Furthermore, a fourth exemplary aspect of the present invention is a A non-transitory computer readable medium that stores a program to compensate for orthogonality between a real signal and an imaginary signal of complex digital intermediate frequency signals, the program causing a computer to execute processing including: a detecting processing that outputs a detection result indicating whether the complex digital intermediate frequency signals include an image frequency signal having a complex conjugate relationship with a frequency of a desired frequency signal; a first processing that outputs a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient; a second processing that outputs a second signal obtained by multiplying the other of the real signal and the imaginary signal by a third coefficient; and a coefficient specifying processing that specifies the first coefficient and the third coefficient in such a way that the first signal has the same amplitude as the second signal, specifies the second coefficient in such a way that the first signal is orthogonal to the second signal, and selects a sign of the second coefficient depending on the detection result.

According to the exemplary aspects of the present invention, it is possible to provide a technique to compensate for the orthogonality even when both the desired frequency signal and the image frequency signal coexist.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an exemplary configuration of a radio receiving device according to a first exemplary embodiment of the present invention;

FIG. 2 is a block diagram showing an exemplary configuration of an orthogonal compensator according to the first exemplary embodiment of the present invention;

FIG. 3 is a block diagram showing an exemplary configuration of a radio receiving device according to a second exemplary embodiment of the present invention;

FIG. 4 is a block diagram showing an exemplary configuration of an orthogonal compensator according to the second exemplary embodiment of the present invention;

FIG. 5 is a block diagram showing a configuration of a radio signal receiving device disclosed in Japanese Patent No. 3902498; and

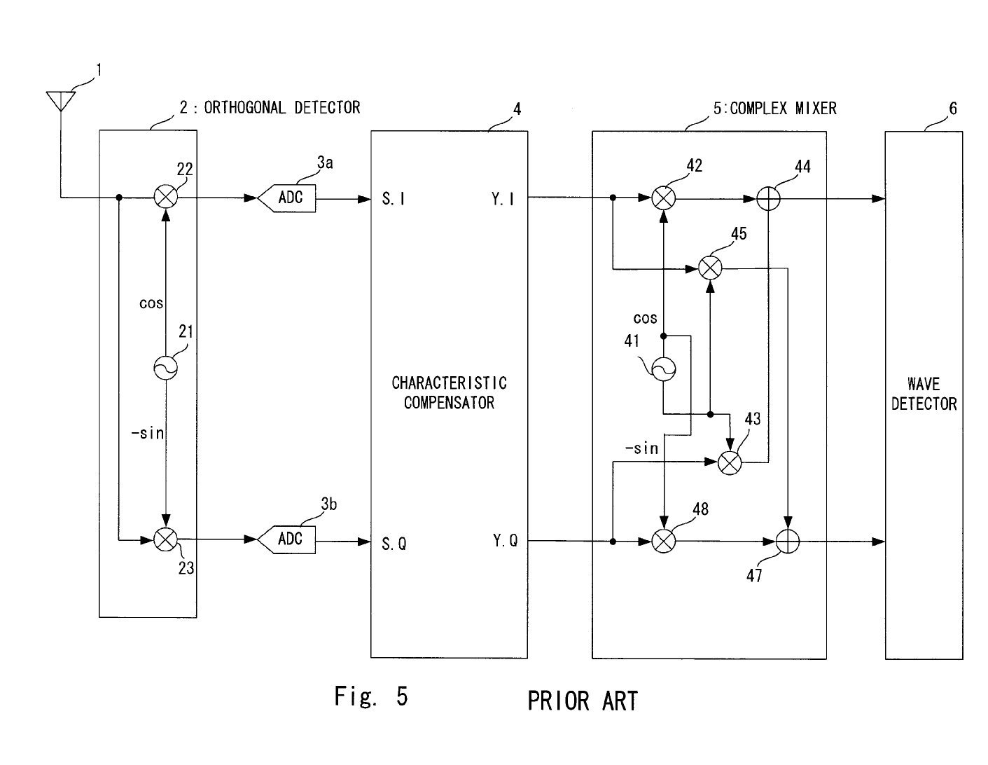

FIG. 6 is a block diagram showing a configuration of an amplitude error compensating circuit disclosed in Japanese Patent No. 3439036.

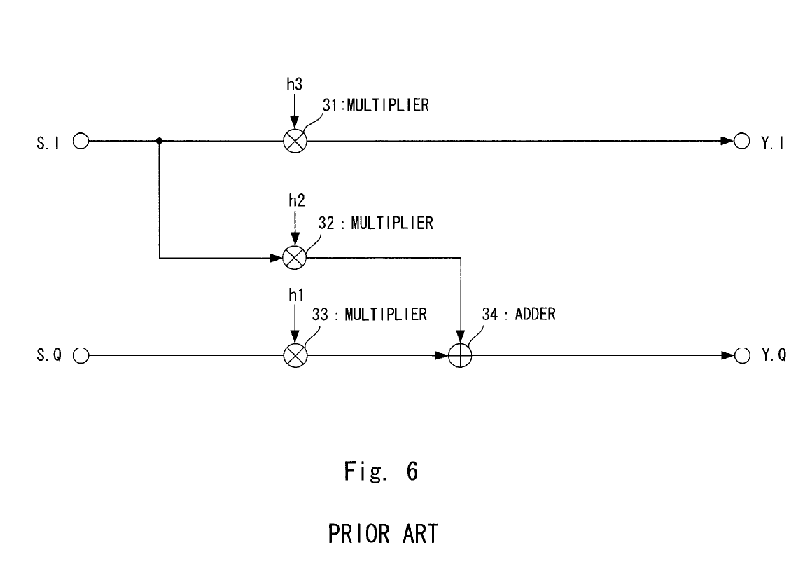

### DETAILED DESCRIPTION OF THE EXEMPLARY EMBODIMENTS

Exemplary embodiments of the present invention will be described hereinafter with reference to the drawings. The following description and the attached drawings are appropriately shortened and simplified to clarify the explanation. In the drawings, the structural elements and equivalents having an identical structure or function are denoted by the identical reference symbols, and the redundant explanation thereof is omitted.

### First Exemplary Embodiment

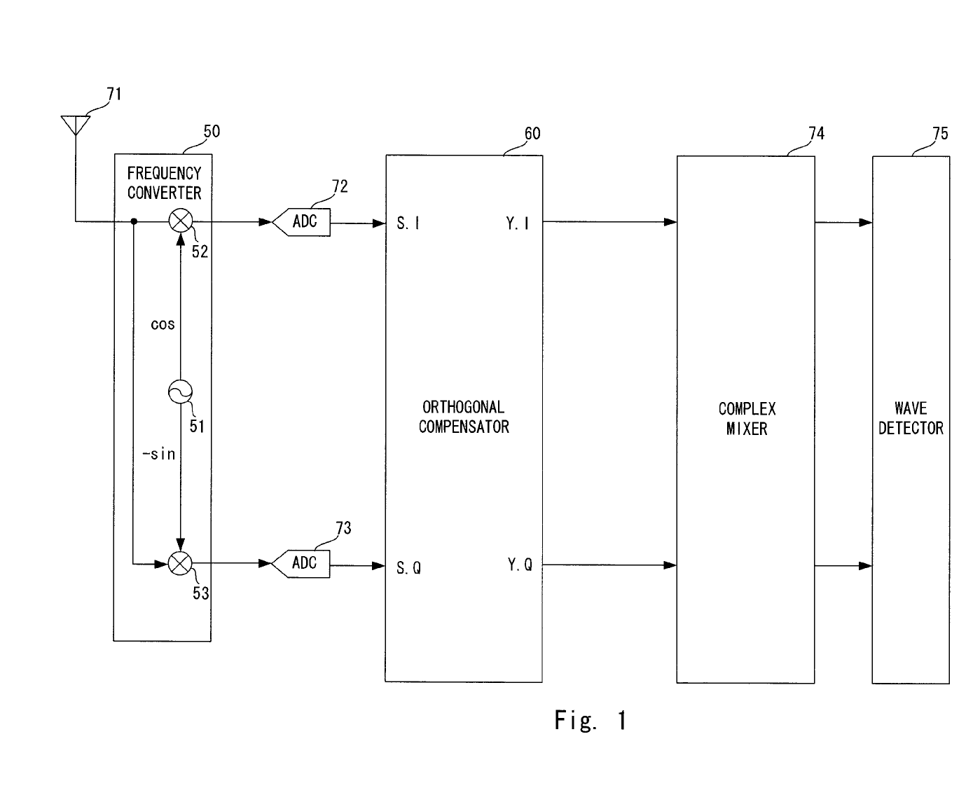

FIG. 1 is a block diagram showing an exemplary configuration of a radio receiving device according to a first exemplary embodiment of the present invention. The radio receiving device includes an antenna 71, a frequency converter 50, quantizers (ADC) 72 and 73, an orthogonal compensator (orthogonality compensating circuit) 60, a complex mixer 74, and a wave detector 75.

The frequency converter 50 obtains complex intermediate frequency signals depending on the frequency of a received signal by using a local signal represented by a complex signal. Specifically, the mixers 22 and 23 perform frequency conversion using a signal cos and a signal −sin which are generated by a local-generated signal generator 51, resulting in conversion into the complex intermediate frequency signals.

The quantizers 72 and 73 quantize the complex intermediate frequency signals to obtain complex digital intermediate frequency signals.

The orthogonal compensator 60 compensates for the orthogonality between a real signal and an imaginary signal in the obtained complex digital intermediate frequency signals.

The complex mixer 74 divides the signal output from the orthogonal compensator 60 into a desired frequency signal and an image frequency signal in accordance with a frequency range.

The wave detector 75 extracts only a frequency band of the desired frequency signal from the signal output from the complex mixer 74 by using a filtering processing, and detects the signal output after the filtering processing.

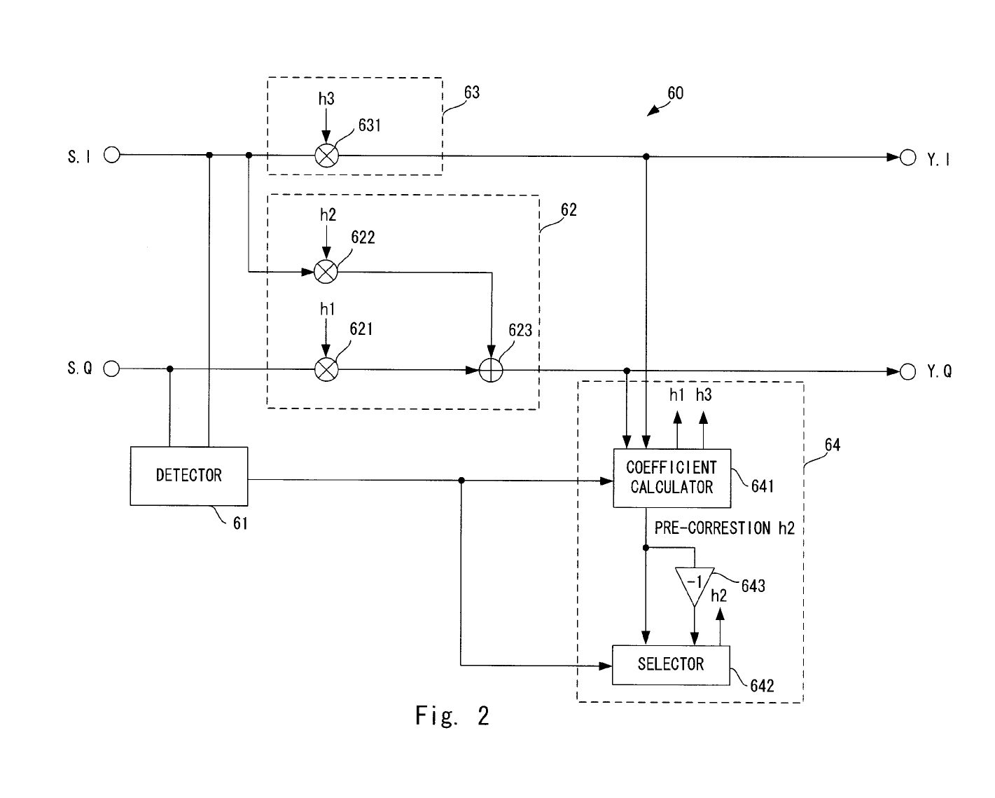

Next, the orthogonal compensator 60 will be explained using a specific configuration example. FIG. 2 is a block diagram showing an exemplary configuration of the orthogonal compensator (orthogonality compensating device).

The orthogonal compensator 60 shown in FIG. 2 includes a detector 61, a first processing unit 62, a second processing unit 63, and a coefficient specifying unit 64.

The detector 61 detects the image frequency signal from input components output from the quantizers 72 and 73, and outputs a detection result indicating whether the input components include the image frequency signal or not. That is to say, the detector 61 outputs the detection result indicating whether the complex digital intermediate frequency signals include the image frequency signal which has a complex conjugate relationship with the desired frequency signal.

The first processing unit 62 outputs a first signal (first calculation signal) which is obtained by adding a first scalar signal and a second scalar signal. The first scalar signal is obtained by multiplying one of the real signal (signal I) and the imaginary signal (signal Q) by a first coefficient h1. The second scalar signal is obtained by multiplying the other of the real signal and the imaginary signal by a second coefficient h2. Referring to FIG. 2, the first processing unit 62 outputs the first signal which is obtained by adding a first scalar signal obtained by multiplying the imaginary signal by the first coefficient h1, and a second scalar signal obtained by multiplying the real signal by the second coefficient h2.

FIG. 2 shows, by way of example, that the first processing unit 62 is composed of multipliers 621 and 622, and an adder 623. The multiplier 621 multiplies the imaginary signal by the first coefficient h1. The multiplier 622 multiplies the real signal by the second coefficient h2. The adder 623 adds signals (the first scalar signal and the second scalar signal) respectively output from the multipliers 621 and 622.

The second processing unit 63 outputs a second signal (second calculation signal) which is obtained by multiplying the other of the real signal and the imaginary signal by a third coefficient h3. Referring to FIG. 2, the second processing unit 63 outputs the second signal which is obtained by multiplying the real signal by the third coefficient h3.

FIG. 2 shows, by way of example, that the second processing unit 63 is composed of a multiplier 631 which multiplies the real signal by the third coefficient h3.

The coefficient specifying unit 64 specifies the first coefficient h1 and the third coefficient h3 in such a way that the first signal has the same amplitude as the second signal, and specifies the second coefficient h2 in such a way that the first signal is orthogonal to the second signal.

The coefficient specifying unit 64 selects the sign of the second coefficient h2 depending on the detection result from the detector 61. Specifically, the coefficient specifying unit 64 sets the sign of the second coefficient h2 to plus or minus depending on the detection result. As a result, the first processing unit 62 adds or subtracts the second scalar signal multiplied by the second coefficient h2.

Further, the coefficient specifying unit 64 suspends updating of the first coefficient h1, the second coefficient h2, and the third coefficient h3 depending on the detection result from the detector 61. Specifically, the coefficient specifying unit 64 suspends updating of the coefficients when the input components include the image frequency signal.

FIG. 2 shows, by way of example, that the coefficient specifying unit 64 is implemented the above-mentioned function using a coefficient calculator 641, a selector 642, and sign setter 643.

The coefficient calculator 641 calculates the first coefficient h1, the second coefficient h2, and the third coefficient h3 using the real signal and the imaginary signal. The coefficient calculator 641 performs calculation to ensure the amplitude and the orthogorality, as described above regarding the coefficient specifying unit 64. The coefficient calculator 641 suspends updating of the first coefficient h1, the second coefficient h2, and the third coefficient h3 depending on the detection result from the detector 61. For example, the coefficient calculator 641 calculates (updates) the coefficients using the expression (5).

The selector 642 selects the sign of the second coefficient h2 depending on the detection result from detector 61.

The sign setter 643 sets the sign of the second coefficient h2 to minus.

The provision of the orthogonal compensator 60 eliminates the need for the radio receiving device to wait until detection of a condition where the image frequency signal is relatively stable, in the case of receiving the desired frequency signal and the image frequency signal. In particular, when the phase error (3 as described in the related art occurs, the direction of adaptive control is reverse in the related art. In this exemplary embodiment, the orthogonal compensator 60 selects the sign of the second coefficient depending on whether the received signal includes the image frequency signal or not. This makes it possible to eliminate the effect of the image frequency signal, and to eliminate the need to wait until detection of the condition where the image frequency signal is relatively stable

The operation of the orthogonal compensator 60 according to this exemplary embodiment will be explained in detail.

In the case of receiving the desired frequency signal, the detector 61 outputs the detection result indicating that the received signal includes no the image frequency signal. The coefficient specifying unit 64 outputs the second coefficient h2 corresponding to the detection result.

The first processing unit 62 adds the first scalar signal obtained by multiplying one signal of the input components by the first coefficient h1, and the second scalar signal obtained by multiplying the other signal by the second coefficient h2 depending on the detection result from the detector 61.

The coefficient specifying unit 64 updates the first coefficient h1, the second coefficient h2, and the third coefficient h3 so that the first signal output from the first processing unit 62 and the second signal output from the second processing unit 63 have an orthogonal relationship and have the same amplitude.

On the other hand, in the case of receiving the image frequency signal, the detector 61 detects that the received signal includes the image frequency signal, and outputs the detection result thereof to the coefficient specifying unit 64. The coefficient specifying unit 64 suspends coefficient updating depending on the detection result, and outputs the second coefficient h2 corresponding to the detection result to the first processing unit 62.

The first processing unit 62 subtracts the second scalar signal obtained by multiplying the other signal of the input components by the second coefficient h2 from the first scalar signal obtained by multiplying one signal of the input components by the first coefficient h1 depending on the detection result from the detector 61.

In this way, the coefficient specifying unit 64 allows the first processing unit 62 to control the addition or subtraction of the first scalar signal obtained by multiplying one signal of the input components by the first coefficient h1 and the second scalar signal obtained by multiplying the other signal by the second coefficient h2, depending on the detection result from the detector 61.

Therefore, the desired frequency signal makes it possible to perform control for compensating for the orthogonality with the image signal, without the need for the embodiment disclosed in Japanese Patent No. 3439036 and without waiting for the arrival of the image signal, for example.

### Second Exemplary Embodiment

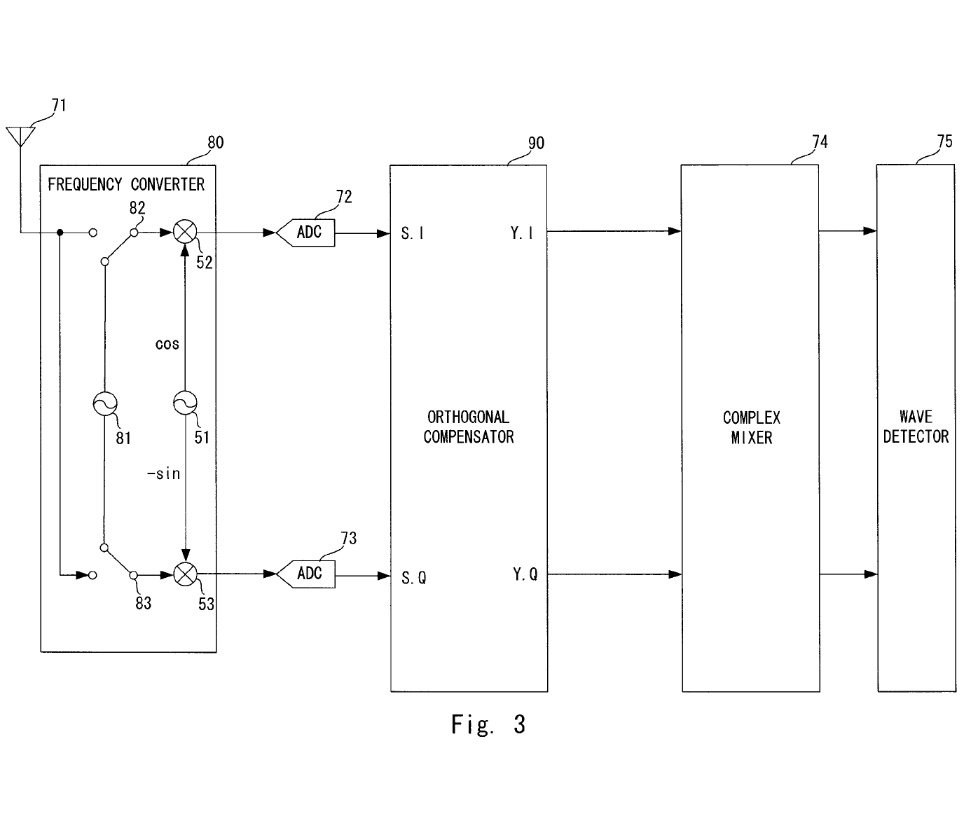

FIG. 3 is a block diagram showing an exemplary configuration of a radio receiving device according to a second exemplary embodiment of the present invention. In the radio receiving device of this exemplary embodiment, a frequency converter 80 further includes a function that generates a revision signal to be output to the quantizers 72 and 73. Specifically, in addition to the function to obtain the complex intermediate frequency signals depending on the frequency of the received signal using the local signal represented by a complex signal, the converter 80 includes a revision signal generator 81 and switches 82 and 83.

The revision signal generator 81 generates a revision signal.

The switches 82 and 83 select a signal to be output to the quantizers 72 and 73. In particular, the switches 82 and 83 select one of the received signal (the desired frequency signal or the image frequency signal) received by the antenna 71 and the revision signal generated by the revision signal generator 81.

The revision signal is a known signal which is used to calculate a coefficient in a state unaffected by a radio wave environment.

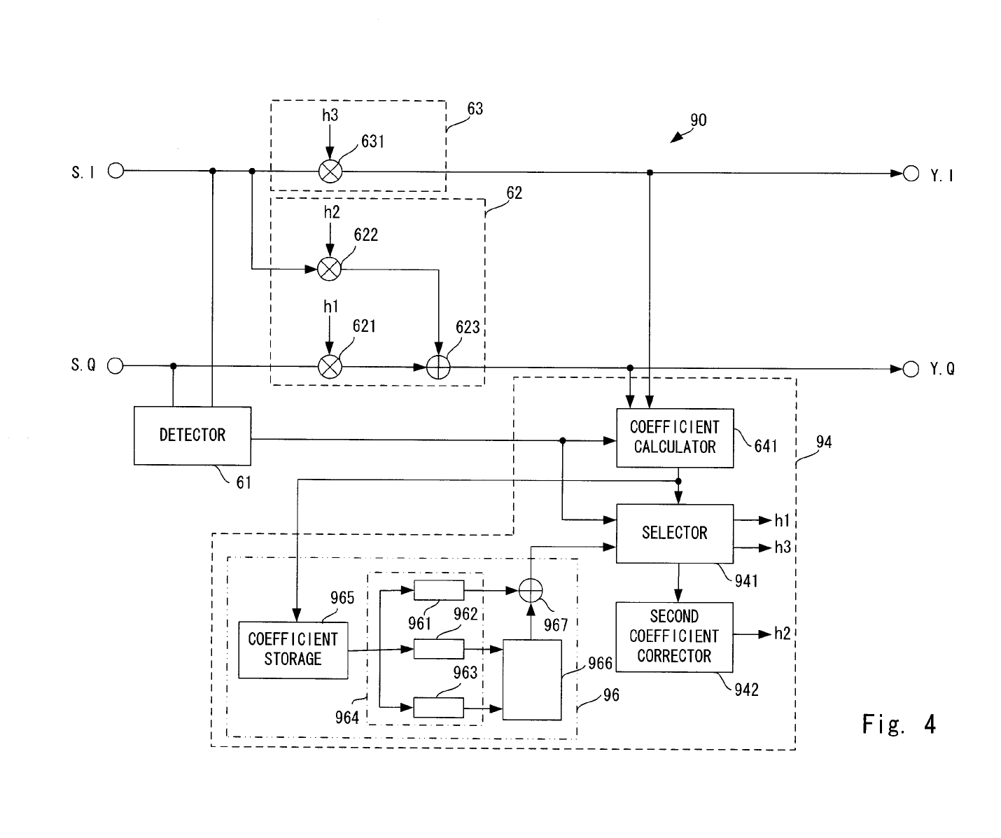

FIG. 4 shows an exemplary configuration of the orthogonal compensator of this exemplary embodiment. A coefficient specifying unit 94 includes the coefficient calculator 641, a selector 941, a second coefficient corrector 942, and the coefficient corrector 96. The coefficient corrector 96 includes a register unit 964, a coefficient storage 965, a correction amount calculator 966, and an adder 967.

The selector 941 selects one of a coefficient calculated by the coefficient calculator 641 and a coefficient calculated by the adder 967. The selector 941 selects values for the first coefficient h1, the second coefficient h2, and the third coefficient h3, respectively. Then, the selector 941 outputs selected the first coefficient h1 to the first processing unit 62, the selected second coefficient h2 to the second coefficient corrector 942, and the selected third coefficient h3 to the second processing unit 63.

The second coefficient corrector 942 corrects the second coefficient h2 selected by the selector 941.

The register unit 964 is a storage area (memory) to hold a number of coefficient values for the first coefficient h1, the second coefficient h2, and the third coefficient h3. The register unit 964 includes a first register 961, a second register 962, and a third register 963. The register unit 964 holds three kinds of information for each coefficient in each register.

The coefficient storage 965 stores the first coefficient h1, the second coefficient h2, and the third coefficient h3, which are calculated by the coefficient calculator 641, in the register unit 964.

The correction amount calculator 966 calculates a correction amount to fix a coefficient value with time. For example, the correction amount calculator 966 calculates a correction amount (an amount of temperature drift) that changes with temperature change. In FIG. 4, the correction amount calculator 966 calculates correction amounts with respect to the first coefficient h1, the second coefficient h2, and the third coefficient h3, respectively.

The adder 967 subtracts the correction amount calculated by the correction amount calculator 966 from the coefficient value held in the first register 961 with respect to each of the first coefficient h1, the second coefficient h2, and the third coefficient h3.

The coefficient corrector 96 updates values of the first coefficient h1, the second coefficient h2, and the third coefficient h3, referring to the coefficients calculated by the coefficient calculator 641 and a number of coefficient values held in the register unit 964.

The following description will be given using the second coefficient h2 chosen from among the first coefficient h1, the second coefficient h2, and the third coefficient h3, and assuming that the second coefficient h2 stored in the first register 961 is a value “h2-1”, the second coefficient h2 stored in the second register 962 is a value “h2-2”, and the second coefficient h2 stored in the third register 963 is a value “h2-3”. Operations of each component of the first coefficient h1 and the third coefficient h3 are similar to those of the second coefficient h2 except for the second coefficient corrector 942.

Exemplary operations will be explained with reference to FIG. 4. When the power of the radio receiving device is turned on, the revision signal generator 81 generates the revision signal. The switches 82 and 83 are switched so as to output the revision signal.

When the power is turned on, the coefficient specifying unit 94 receives a real signal or an imaginary signal, which is replaced with the received signal received through the antenna 71, depending on the revision signal. First, the coefficient calculator 641 calculates the second coefficient h2 (revision value of the second coefficient h2) using the revision signal. The coefficient storage 965 stores the calculated second coefficient h2 as the value h2-1 in the first register 961.

Next, after a lapse of a given time since the power of the radio receiving device is turned on, the coefficient calculator 641 calculates the second coefficient h2 (initial value of the second coefficient) using the received signal received by the antenna 71. The given time is a period where each function is started up upon power-on, and the radio receiving device starts to receive the signal received through the antenna 71, for example. In this case, the coefficient calculator 641 may first use the received signal received through the antenna 71. The coefficient storage 965 stores the second coefficient h2, which is calculated by the coefficient calculator 641 using the received signal received through the antenna 71, as the value h2-2 in the second register 962.

After a lapse of an arbitrary time, the coefficient calculator 641 calculates the second coefficient h2 (elapsed value of the second coefficient) using a newly received signal. The coefficient storage 965 stores the second coefficient h2 newly calculated by the coefficient calculator 641 as the value h2-3 in the third register 963. Further, after a lapse of an arbitrary time, the coefficient calculator 641 calculates the second coefficient h2 using a newly received signal. The coefficient storage 965 replaces the value h2-3 held in the third register 963 with the second coefficient h2 newly calculated. As a result, the value h2-3 held in the third register 963 is updated after a lapse of an arbitrary time.

The coefficient corrector 96 generates the second coefficient h2 using information of the second coefficient h2 held in the register unit 964. In particular, the correction amount calculator 966 calculates a difference between the value h2-2 held in the second register 962 and the value h2-3 held in the third register 963 as the correction amount (amount of temperature drift). Then, in the coefficient corrector 96, the adder 967 adds the correction amount calculated and the value h2-1 held in the first register 961 when the sign is plus, or subtracts the correction amount calculated from the value h2-1 when the sign is minus to calculate the second coefficient h2.

In the case of receiving the desired frequency signal, it is determined that the desired frequency signal is larger than the image frequency signal. For this reason, the detector 61 outputs the detection result indicating that no image frequency signal is detected. The selector 941 selects the second coefficient h2 calculated by the coefficient calculator 641 depending on the detection result.

In the case of receiving the image frequency signal, the detector 61 outputs the detection result indicating that the image frequency signal is detected. The selector 941 selects the second coefficient h2 which is corrected by the coefficient calculator 96 by using the second coefficient h2 calculated by the coefficient calculator 641. In this case, the selector 941 selects the second coefficient h2 obtained by subtracting the amount of temperature drift calculated by the correction amount calculator 966 from the value h2-1 held in the first register 961.

The second coefficient corrector 942 corrects the second coefficient h2, which is selected by the selector 941, by using an expression (10).

a=√{(sin²φ/(1−sin²φ)} (10)

Where variable φ is the value of the second coefficient h2 selected by the selector 941, and the correction amount “a” is the value output from the second coefficient corrector 942.

The second coefficient h2 corrected by the second coefficient corrector 942 is output to the first processing unit 62.

The second coefficient corrector 942 applies the expression (10) to the second coefficient h2, which is subjected to temperature drift correction as needed, i.e., the second coefficient h2 calculated by the second coefficient corrector 942. The second coefficient corrector 942 performs conversion to make a proportional relation between a phase error of the second coefficient h2 and an amount of phase control.

In the case of the expression (6), the signal Y.Q is represented by an expression (11).

$$\begin{matrix}Y . Q = sin ( fif + β ) + h 2 \times cos ( fif ) \\ = √ \{ 1 + {( h 2 )}^{2} \} * sin ( fif + β + θ )\end{matrix} \\ where θ = {sin}^{- 1} ( h 2 / √ \{ 1 + {( h 2 )}^{2} \} ) \qquad ( 11 )$$

As shown the expression (11), a phase θ is controlled to be equal to −β, that is, controlled so that the Y.I and Y.Q signals shown in FIG. 2 are orthogonal to each other, in accordance with the second coefficient h2. As indicated by the expression (11), the second coefficient h2 is not the phase θ itself. The phase has no proportional relation, as the control value is transformed by the expression (11). The second coefficient h2 is converted by the expression (10), so that the relation between the phase θ and the second coefficient h2, that is, an amount of orthogonal control, becomes linear. The second coefficient corrector 942 is not required when only the phase error β occurs and the phase error a does not occur.

In the detector 61, immediately before the detection result indicating that the image frequency signal is detected is output, values of the second coefficient h2 calculated by the coefficient calculator 641 and the second coefficient h2 corrected by the coefficient corrector 96 are equal, but the signs of these coefficients are different. That is because the direction of adaptive control is reverse when the phase error β occurs in each case of receiving the desired frequency signal and the image frequency signal as described above. According to the expression (11), the difference in sign of the second coefficient h2 is directly reflected in the sign of the phase θ. For this reason, the second coefficient corrector 942 is unnecessary.

On the other hand, when the phase error a described above is added to the phase error β, in each case of receiving the desired frequency signal or the image frequency signal respectively, the phase error α is obtained such that the direction of adaptive control is in the forward direction. Accordingly, the phase error α is given as an scalar to the phase error β, so that the values and signs of the second coefficient h2 calculated by the coefficient calculator 641 and the second coefficient h2 corrected by the coefficient corrector 96 are different.

In the case of adding the temperature drift, an amount of temperature drift T calculated by the correction amount calculator 966 includes an error r occurring in the expression (11) in the case of receiving the image frequency signal. As a result, T+τ is obtained, resulting in no compensation of the temperature drift. The expression (10) is used to achieve a proportional relation in which the value h2 is zero (h2=0), resulting in disappearance of the error τ described above. This provides an advantage that the characteristics compensation can be carried out more accurately.

According to this exemplary embodiment, the orthogonality can be compensated even if the phase error α and the phase error β indicated the expressions (6), (7), (8), and (9) coexist. In particular, the phase error α is compensated in the second coefficient h2 calculated depending on the revision signal. The phase error β is compensated by subtracting the correction amount for ensuring the temperature drift, from the value h2-1. As a result, the orthogonality with respect to the image frequency signal can be compensated more accurately, compared to the first exemplary embodiment, without waiting for arrival of the image frequency signal, by constantly monitoring the condition of the desired frequency signal.

Since the orthogonal compensator according to this exemplary embodiment has the configuration as shown in FIGS. 3 and 4, register unit can hold three kinds of values. In particular, the first register holds the first value calculated by the initial orthogonality compensation using the revision signal. The second register holds the second value calculated by the orthogonality compensation using the revision signal. The third register holds the third value calculated by othtogonality compensation using the desired frequency signal after a lapse of a given time. The amount of temperature drift in the desired frequency signal is calculated using the second value and the third value. Then, the coefficient can be calculated by subtracting the amount of temperature drift in the desired frequency signal from the value corrected initially by the revision signal (for example, h2-1).

In the case of calculating the coefficient depending on the revision signal, the coefficient specifying unit 94 can correct the phase error a that depends on a delay caused by characteristics variations of a device circuit included in the radio receiving device, and property fluctuation due to temperature change, because the revision signal is a known signal. Further, in the case of calculating the coefficient based on the received signal, the coefficient specifying unit 94 can detect the correction amount of the phase error β occurring due to the influence of communication environments such as a radio wave sate in which the received signal is transferred. Accordingly, the coefficient specifying unit 94 can calculate the coefficient to correct the phase error α and the phase error β using the coefficient calculated depending on the revision signal and the coefficient calculated depending on the received signal. This makes it possible to compensate for the initial phase variations more accurately than the first exemplary embodiment.

In general, a compensation depending on temperature change is necessary after start-up of the radio receiving device. The compensation depending on temperature change can be carried out by obtaining a difference between the coefficient calculated based on the received signal initially and the coefficient calculated based on the received signal after a lapse of a given time.

While FIG. 4 shows an exemplary configuration in which the coefficient corrector 96 corrects each value of the first, second, and third coefficients, the function of the coefficient corrector 96, for correcting the value of the first coefficient h1 or the third coefficient h3 may be omitted. For example, the coefficient corrector 96 may be configured to calculate the correction amount (temperature drift) only with respect to the second coefficient h2, and to output the first coefficient h1 calculated by the coefficient calculator 641 to the first processing unit 62, and output the third coefficient h3 calculated by the coefficient calculator 641 to the second processing unit 63. However, it is preferable that the coefficient corrector 96 have the functions for the first coefficient h1, the second coefficient h2, and the third coefficient h3, since a higher accuracy can be achieved when the functions for every coefficient are carried out.

### Third Exemplary Embodiment

A third exemplary embodiment will be described in which the value of the coefficient (here, the second coefficient) is limited. Because the error amount which is the phase error a or the phase error β as described above is mainly caused by characteristics variations or variations due to environmental changes, the error amount is generally negligible if the correction can be carried out several times. Therefore, an exemplary configuration is employed to limit a permissible range of the coefficient, and to control a limiter to prevent any difficulty in adjustment of the coefficient due to a rapid change of an input signal electric field. Specifically, a coefficient specifying unit calculates the second coefficient h2 so as to be set within a given range. The coefficient specifying unit specifies a maximum value when the value calculated is larger than the given range, and specifies a minimum value when the value is smaller than the given range.

Even when adaptive convergence is difficult due to a rapid change of an input signal electric field or depending on the quality of the received signal, a steady condition of the adaptive signal processing can be recovered without spread of the adaptive signal processing, by limiting the permissible range of the coefficient.

### Fourth Exemplary Embodiment

The above exemplary embodiments provide the same effects when the phase correcting control is provided to one or both of the signal paths. It is preferable that the phase correcting control is provided to the both of the paths for the real signal and the imaginary signal so that the correction control amounts are set in reverse directions for the paths, if the size of hardware permits.

In that case, when an amplitude change occurs depending on the phase control, the change is made by the same amplitude amount for both passes, which eliminates the need for the first coefficient h1 and the third coefficient h3, as long as a circuit is employed in which the characteristics variations of the circuit and the characteristics variations due to temperature change do not vary in the amplitude direction.

Further, the orthogonal compensator of this exemplary embodiment includes the coefficient specifying units 64 and 94 to update the coefficients in such a way that the output signal from the first processing unit 62 and the output signal from the second processing unit 63 have an orthogonal relationship and the same amplitude. The exemplary embodiments 1 and 2 show an example for applying the CMA, however, the control may also be carried out such that the output signal from the first processing unit 62 and the output signal from the second processing unit 63 have the same amplitude. That is, a calculation may be made using the following expression (12).

h_{1,k}=h_{1,k-1}−μ*e₁

h_{2,k}=h_{2,k-1}−μ*e₂

h_{3,k}=h_{3,k-1}+μ*e₁

where μ is a parameter to specify a convergence capacity,

e₁=Y.I²−Y.Q²,

e₂=Y.I*Y.Q. (12)

In this case, a control is performed such that the output signal from the first processing unit 62 and the output signal from second processing unit 63 have relatively the same amplitude. This makes it possible to extract a signal intensity from the signal subjected orthogonality compensation, which is advantageous for configuring a receiver.

### Other Exemplary Embodiments

The functions of the orthogonal compensator (orthogonality compensating device) and the orthogonality compensating method described in the above exemplary embodiments may be implemented by hardware, firmware, software, or a combination thereof, for example. In the case of using software, the functions may be implemented to cause a computer to execute instructions included in a program. The program is loaded to a computer memory to execute the instructions under control of a central processing unit (CPU). The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

In the radio receiving device shown as FIG. 1, the program may be executed using a CPU and a memory in the orthogonal compensator, or using a CPU to control the complex mixer 74 or the wave detector 75 and a memory to be usable by the CPU.

The program causes the computer to execute at least the following processing: (1) a detecting processing that outputs a detection result indicating whether the complex digital intermediate frequency signals include an image frequency signal having a complex conjugate relationship with a frequency of a desired frequency signal; (2) a first processing that outputs a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient; (3 a second processing that outputs a second signal obtained by multiplying the other of the real signal and the imaginary signal by a third coefficient; and (4) a coefficient specifying processing that specifies the first coefficient and the third coefficient in such a way that the first signal has the same amplitude as the second signal, specifies the second coefficient in such a way that the first signal is orthogonal to the second signal, and selects a sign of the second coefficient depending on the detection result.

As described above, the orthogonal compensator (orthogonality compensating device) according to any one of the exemplary embodiments provides the following advantageous effect. That is, regarding the values of the coefficient (second coefficient h2) for use in compensating for the orthogonality between the real signal and the imaginary signal, the coefficient value obtained based on the image frequency signal is equal to the coefficient value obtained based on the desired frequency signal. For this reason, the coefficient value obtained after orthogonality compensation based on the desired frequency signal is also effective in receiving the image frequency signal. Consequently, the ability of eliminating the image frequency signal is obtained before arrival of the image frequency signal.

The provision of a means to generate the revision signal in the radio receiving device, and means to hold a plurality of coefficients (for example, a memory, or a register) makes it possible to update the coefficients by referring to values of the plurality of the coefficients. The use of the revision signal makes it possible to compensate for variations in initial phase of the local signals cos and −sin represented by complex signals of the frequency converter. Therefore, an effect of higher accuracy is obtained.

Further, applying the amplitude limitation to the coefficients h1, h2, and h3 makes it possible to recover a steady condition without spread of the adaptive signal processing, even when the adaptive conversion is difficult due to a rapid change of an input signal electric field and depending on the quality of the received signal.

For example, according to any one of above exemplary embodiments, it is possible to provide the radio receiving device including an orthogonal compensator which is preferable for an in-vehicle tuner and suppresses the deterioration of the ability to eliminate the image frequency signal due to a deterioration in characteristics or incompleteness of a circuit or a device.

The first to fourth exemplary embodiments and other exemplary embodiments described above can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An orthogonality compensating device that compensates for orthogonality between a real signal and an imaginary signal of complex digital intermediate frequency signals, the orthogonality compensating device comprising:
a detector that outputs a detection result including whether the complex digital intermediate frequency signals include an image frequency signal having a complex conjugate relationship with a frequency of a desired frequency signal;
a first processing unit that outputs a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient;
a second processing unit that outputs a second signal obtained by multiplying the other of the real signal and the imaginary signal by a third coefficient;
a coefficient specifying unit that specifies the first coefficient and the third coefficient such that the first signal has the same amplitude as the second signal, specifies the second coefficient such that the first signal is orthogonal to the second signal, and selects a sign of the second coefficient depending on the detection result from the detector.

2. The orthogonality compensating device according to claim 1, wherein the coefficient specifying unit suspends updating of each of the first coefficient, the second coefficient, and the third coefficient depending on the detection result.

3. The orthogonality compensating device according to claim 2, wherein the coefficient specifying unit includes:
a coefficient calculator that calculates the first coefficient, the second coefficient, and the third coefficient, and suspends updating of each of the first coefficient, the second coefficient, and the third coefficient depending on the detection result; and
a selector that selects the sign of the second coefficient depending on the detection result, and notifies the coefficient calculator of the sign.

4. The orthogonality compensating device according to claim 3, further comprising:
a revision signal generator that generates a revision signal,
wherein the coefficient specifying unit further includes a coefficient corrector that holds a revision value of the second coefficient calculated based on the revision signal, an initial value of the second coefficient calculated based on a first received signal, and an elapsed value of the second coefficient calculated based on a second received signal received after a lapsed of a given time from the calculation of the initial value, calculates a correction amount associated with an elapsed time by using the initial value and the elapsed value, and outputs a value obtained by subtracting the correction value from the revision value as the second coefficient to be corrected, and
wherein the selector selects one of the second coefficient calculated by the coefficient calculator and the second coefficient to be updated by the coefficient corrector.

5. The orthogonality compensating device according to claim 4, wherein the coefficient corrector includes:
a register unit that holds the revision value, the initial value, and the elapsed value; and
a calculator that calculates an amount of temperature drift associated with the elapsed time by using the initial value and the elapsed value as the correction amount, and subtracts the amount of temperature drift from the revision value.

6. The orthogonality compensating device according to claim 1, wherein the coefficient specifying unit specifies a permissible range of the second coefficient, and specifies the value of the second coefficient in the specified range.

7. The orthogonality compensating device according to claim 2, wherein the coefficient specifying unit specifies a permissible range of the second coefficient, and specifies the value of the second coefficient in the specified range.

8. The orthogonality compensating device according to claim 3, wherein the coefficient specifying unit specifies a permissible range of the second coefficient, and specifies the value of the second coefficient in the specified range.

9. The orthogonality compensating device according to claim 4, wherein the coefficient specifying unit specifies a permissible range of the second coefficient, and specifies the value of the second coefficient in the specified range.

10. The orthogonality compensating device according to claim 5, wherein the coefficient specifying unit specifies a permissible range of the second coefficient, and specifies the value of the second coefficient in the specified range.

11. The orthogonality compensating device according to claim 6, wherein the coefficient specifying unit specifies a permissible range of at least one of the first coefficient and the third coefficient, and specifies the value of at least one of the first coefficient and the third coefficient in the specified range.

12. The orthogonality compensating device according to claim 7, wherein the coefficient specifying unit specifies a permissible range of at least one of the first coefficient and the third coefficient, and specifies the value of at least one of the first coefficient and the third coefficient in the specified range.

13. The orthogonality compensating device according to claim 8, wherein the coefficient specifying unit specifies a permissible range of at least one of the first coefficient and the third coefficient, and specifies the value of at least one of the first coefficient and the third coefficient in the specified range.

14. The orthogonality compensating device according to claim 9, wherein the coefficient specifying unit specifies a permissible range of at least one of the first coefficient and the third coefficient, and specifies the value of at least one of the first coefficient and the third coefficient in the specified range.

15. The orthogonality compensating device according to claim 10, wherein the coefficient specifying unit specifies a permissible range of at least one of the first coefficient and the third coefficient, and specifies the value of at least one of the first coefficient and the third coefficient in the specified range.

16. A radio receiving device comprising:
a frequency converter that obtains complex intermediate frequency signals depending on a frequency of a received signal by using a local signal represented by a complex signal;
a quantizer that transforms the complex intermediate frequency signals to complex digital intermediate frequency signals;
an orthogonal compensator that compensates for orthogonality between a real signal and a imaginary signal of the complex digital intermediate frequency signals by using the orthogonality compensating device according to claim 1;
a complex mixer that divides the real signal and the imaginary signal compensated for by the orthogonal compensator into the desired frequency signal and the image frequency signal in accordance with a frequency range, the image frequency signal falling within a rage of image frequency having a complex conjugate relationship with a frequency of the desired frequency signal; and
a detector that detects a signal output from the complex mixer.

17. An orthogonality compensating method that compensates for orthogonality between a real signal and an imaginary signal of complex digital intermediate frequency signals, the orthogonality compensating method comprising:
outputting a detection result indicating whether the complex digital intermediate frequency signals include an image frequency signal having a complex conjugate relationship with a frequency of desired frequency signal;
outputting a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient;
outputting a second signal obtained by multiplying the other of the real signal and the imaginary signal by a third coefficient;
specifying the first coefficient and the third coefficient in such a way that the first signal has the same amplitude as the second signal;
specifying the second coefficient in such a way that the first signal is orthogonal to the second signal; and
selecting a sign of the second coefficient depending on the detection result.

18. A non-transitory computer readable medium that stores a program to compensate for orthogonality between a real signal and an imaginary signal of complex digital intermediate frequency signals, the program causing a computer to execute processing comprising:
a detecting processing that outputs a detection result indicating whether the complex digital intermediate frequency signals include an image frequency signal having a complex conjugate relationship with a frequency of a desired frequency signal;
a first processing that outputs a first signal obtained by adding a first scalar signal and a second scalar signal, the first scalar signal being obtained by multiplying one of the real signal and the imaginary signal by a first coefficient, the second scalar signal being obtained by multiplying the other of the real signal and the imaginary signal by a second coefficient;
a second processing that outputs a second signal obtained by multiplying the other of the real signal and the imaginary signal by a third coefficient; and
a coefficient specifying processing that specifies the first coefficient and the third coefficient in such a way that the first signal has the same amplitude as the second signal, specifies the second coefficient in such a way that the first signal is orthogonal to the second signal, and selects a sign of the second coefficient depending on the detection result.
